(19) United States
(12) Patent Application Publication
(10) Pub. No.: US 2007/0025035 A1
(43) Pub. Date: Feb. 1, 2007

(54) Electrostatic discharge protection circuit with reduced mounting area and junction capacitance

(76) Inventors: Jang Hoo Kim, Kyoungki-do (KR); Kook Whee Kwak, Kyoungki-do (KR)

Correspondence Address: LADAS & PARRY LLP, 224 SOUTH MICHIGAN AVENUE, SUITE 1600, CHICAGO, IL, 60604, US

(21) Appl. No.: 11/493,087

(22) Filed: Jul. 26, 2006

(30) Foreign Application Priority Data
Jul. 26, 2005 (KR) 10-2005-0067872

(51) Int. Cl. H02H 9/00

(52) U.S. Cl. 361/56

(57) ABSTRACT

The electrostatic discharge protection circuit prevents internal elements from being damaged due to static electricity. The ESD protection circuit includes a first voltage line connected to a power source voltage pad, a second voltage line connected to a ground voltage pad, an ESD protection unit connected between the first voltage line and the second voltage line to provide a static electricity discharge path, and at least one switch connected between an input/output pad and the ESD protection unit to be switched by static electricity.

### BACKGROUND OF THE INVENTION

1. Field of the Invention

The present invention relates, in general, to an electrostatic discharge protection circuit, and more particularly to an electrostatic discharge protection circuit which can prevent internal elements from being damaged due to generation of static electricity.

2. Description of the Related Art

In general, there are various types of failure modes for the circuits integrated in a semiconductor device. Among these, a failure mode due to an electrical overstress and a failure mode due to an electrostatic discharge (hereinafter, the “ESD”) are caused by undesirable electric charges negatively affecting the integrated circuit.

The ESD occurs due to flowing charges generated by static electricity. The ESD is categorized into a human body model (HBM), a machine model (MM), and a charge device model (CDM) classified based on the source generating the static electricity.

The human body model (HBM), as implied by the name, means that an ESD phenomenon is caused by a part of a human body. The machine model (MM) means that an ESD phenomenon is caused due to a contact with, for example, a measurement equipment. The charge device model (CDM) means that an ESD phenomenon is caused by a momentary discharge of the static electricity accumulated in a device due to momentary grounding to the outside.

The electrostatic current generated by an ESD phenomenon inside an integrated circuit will concentrate and flow to the weakest portion of a transistor or a junction or a contact or a gate oxide portion in the integrated circuit, and as a result these components are likely to fail (e.g., by melting) during an ESD phenomenon.

Therefore, an ESD protection circuit is provided for each pad connected to an outside pin in a semiconductor device, in order to protect the internal components of a chip from being damaged due to ESD.

FIG. 1 is a circuit diagram illustrating a conventional ESD protection circuit.

Referring to FIG. 1, the conventional ESD protection circuit comprises an input/output pad 101 connected to a node ‘A’, a power source voltage pad 103 connected to a power source voltage line 102, a ground voltage pad 105 connected to a ground voltage line 104, and an ESD protection unit 110 having ESD protection elements 111 and 112 and an ESD clamp protection element 113. The ESD protection unit 110 may be formed by or include a circuit formed by a MOS transistor, a bipolar transistor, a diode, an SCR, various passive elements, etc.

The ESD protection element 111 is connected between the power source voltage line 102 and the node ‘A’. The ESD protection element 112 is connected between the node ‘A’ and the ground voltage line 104. The ESD clamp protection element 113 is connected between the power source voltage line 102 and the ground voltage line 104.

When a semiconductor chip normally operates, the ESD protection elements 111 and 112 and the ESD clamp protection element 113 (as shown in FIG. 1) are maintained in a turn-off state, thus they impose no influence on the normal circuit operation.

However, when a harmful static electricity is generated in any of the input/output pad 101, the power source voltage pad 103, and the ground voltage pad 105, the ESD protection elements 111, 112 and the ESD clamp protection element 113 are turned on to provide an ESD path to get rid of the harmful static electricity to the power source voltage line 102 or the ground voltage line 104.

A conventional ESD protection circuit is essential for discharging harmful electrostatic charges; however, as shown in FIG. 1, because the junction capacitance of the ESD protection elements 111 and 112 are directly connected to the input/output pad 101, the signal transmission speed and integrity are decreased and deteriorated when a conventional ESD protection circuit such as those shown in FIG. 1 is used in a semiconductor device.

That is to say that the ESD protection elements 111 and 112 are (1) connected to the input/output pad 101, the power source voltage pad 102 or the ground voltage pad 103 and (2) generate a junction capacitance. The junction capacitance decreases and deteriorates the signal transmission speed and integrity.

FIG. 2 is a circuit diagram illustrating another conventional ESD protection circuit.

The conventional ESD protection circuit shown in FIG. 2 performs an ESD protection function through a plurality of ESD protection units 210, 220, each of which is connected to one of input/output pads 201, 202. The ESD protection units 210, 220 are configured in the same manner as the ESD protection unit 110 shown in FIG. 1.

However, the conventional ESD protection circuit of the above occupies a substantial space in a semiconductor chip since each of the ESD protection units 210, 220 must be connected to each respective one of the input/output pads 201, 202.

One conventional technique tries to solve this problem by connecting one ESD protection unit (such as 210) to a plurality of input/output pads 201, 202 to decrease the area occupied by the ESD protection circuit; however, as the plurality of input/output pads 201 and 202 are connected to each other via an ESD protection unit, a short can occur and a proper circuit operation cannot be guaranteed.

### SUMMARY OF THE INVENTION

Accordingly, the present invention has been made in an effort to solve the problems occurring in the related art, and an object of the present invention is to decrease a junction capacitance, which is generated by an ESD protection circuit connected to a pad.

Another object of the present invention is to decrease the area occupied by an ESD protection circuit in a semiconductor chip.

In order to achieve the above and other objects, according to one aspect of the present invention, there is provided an ESD protection circuit including an input/output pad, a power source voltage pad, and a ground voltage pad, comprising a first voltage line connected to the power source voltage pad; a second voltage line connected to the ground voltage pad; an ESD protection unit connected between the first voltage line and the second voltage line to provide a static electricity discharge path; and switching means connected between the input/output pad and the ESD protection unit and switched by static electricity.

In the above configuration, it is preferred that the switching means comprise a diode which is turned on in a forward bias state when the static electricity has a negative voltage and is turned on in a reverse bias state when the static electricity has a positive voltage.

Further, it is preferred that the switching means comprise an NMOS transistor which has a drain terminal connected to the input/output pad and gate and source terminals commonly connected to the ESD protection unit.

In the above configuration, it is preferred that the ESD protection unit comprise a first diode means connected between the first voltage line and the switching means; a second diode means connected between the switching means and the second voltage line; and clamp means connected between the first voltage line and the second voltage line.

In order to achieve the above objects, according to another aspect of the present invention, there is provided an ESD protection circuit including a plurality of input/output pad, a power source voltage pad, and a ground voltage pad, comprising a first voltage line connected to the power source voltage pad; a second voltage line connected to the ground voltage pad; an ESD protection unit connected between the first voltage line and the second voltage line to provide a static electricity discharge path; and a plurality of switching means respectively connected between the plurality of input/output pad and the ESD protection unit and switched by static electricity.

In the above configuration, it is preferred that the switching means comprise a diode which is turned on in a forward bias state when the static electricity has a negative voltage and is turned on in a reverse bias state when the static electricity has a positive voltage.

Further, it is preferred that the switching means comprise an NMOS transistor which has a drain terminal connected to the input/output pad and gate and source terminals commonly connected to the ESD protection unit.

In the above configuration, it is preferred that the ESD protection unit comprise a first diode means connected between the first voltage line and the switching means; a second diode means connected between the switching means and the second voltage line; and clamp means connected between the first voltage line and the second voltage line.

### BRIEF DESCRIPTION OF THE DRAWINGS

The above objects, and other features and advantages of the present invention will become more apparent after a reading of the following detailed description when taken in conjunction with the drawings, in which:

FIG. 1 is a circuit diagram illustrating a conventional ESD protection circuit;

FIG. 2 is a circuit diagram illustrating another conventional ESD protection circuit;

FIG. 3 is a circuit diagram illustrating an ESD protection circuit in accordance with one embodiment of the present invention; and

FIG. 4 is a circuit diagram illustrating an ESD protection circuit in accordance with another embodiment of the present invention.

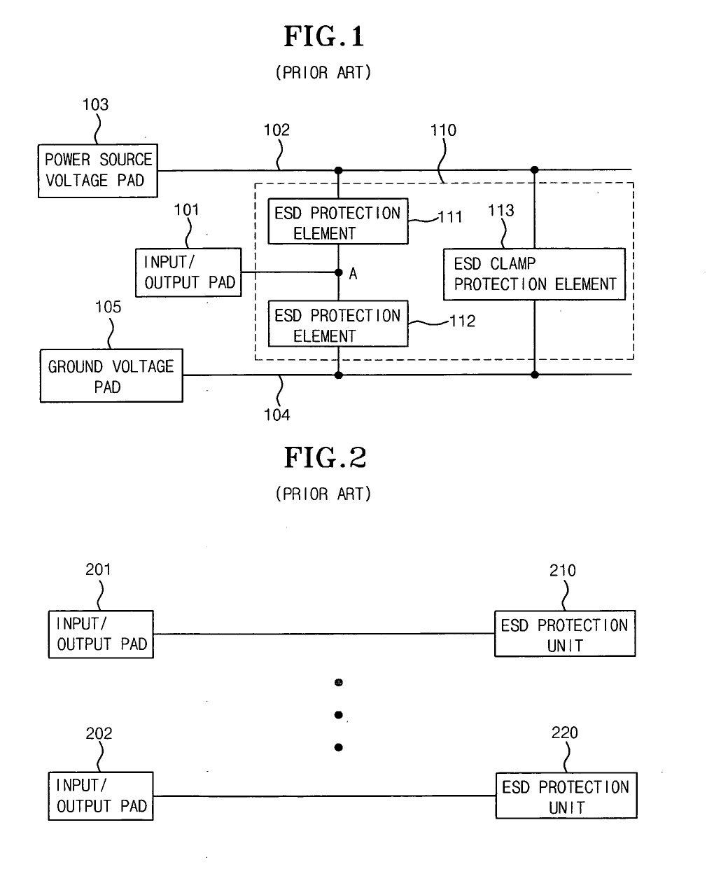

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

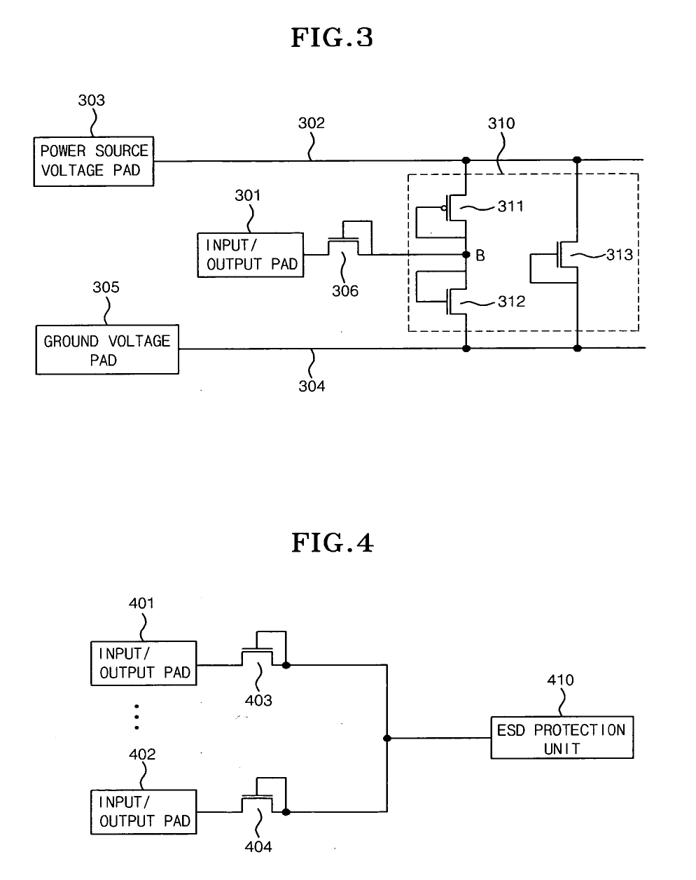

FIG. 3 is a circuit diagram illustrating an ESD protection circuit in accordance with one embodiment of the present invention.

Referring to FIG. 3, the ESD protection circuit in accordance with one embodiment of the present invention comprises an input/output pad 301, a power source voltage pad 303 connected to a power source voltage line 302, a ground voltage pad 305 connected to a ground voltage line 304, an ESD protection unit 310 connected between the power source voltage line 302 and the ground voltage line 304, and a switching element 306 connected between the input/output pad 301 and the ESD protection unit 310.

The ESD protection unit 310 may comprise diodes, a clamp element, etc. For example, as shown in FIG. 3, the ESD protection unit 310 comprises a PMOS transistor 311 which is connected between the power source voltage line 302 and a node ‘B’ to operate as a diode, an NMOS transistor 312 which is connected between the node ‘B’ and the ground voltage line 304 to operate as a diode, and an ESD clamp protection element 313 connected between the power source voltage line 302 and the ground voltage line 304.

The switching element 306 may comprise one or more of various kinds of transistors, although FIG. 3 shows the switching element 306 comprised of an NMOS transistor. The drain terminal of the NMOS transistor 306 is connected to the input/output pad 301, and the gate and source terminals of the NMOS transistor 306 are commonly connected to the node ‘B’.

The ESD protection circuit of FIG. 3 according to an embodiment of the present invention changes its operational characteristics depending on the operational status of a semiconductor chip, namely:

(1) The semiconductor chip is operating normally, i.e., power is applied to the semiconductor chip; or

(2) Static electricity is generated with no power applied to the semiconductor chip.

First, when a semiconductor chip operates normally, i.e., power is being applied to the semiconductor chip, the NMOS transistor 306 of the ESD protection circuit as shown in FIG. 3 is turned off.

More specifically, when power is applied to the semiconductor chip, the voltage difference about the operational voltage of the semiconductor chip would exist between the drain and source terminals of the NMOS transistor 306. Since the operational voltage of the semiconductor chip is lower than the reverse operation voltage of the NMOS transistor 306, the NMOS transistor 306 is maintained in a turn-off state.

Accordingly, the NMOS transistor 306 in the ESD protection circuit is turned off when power is being applied to the semiconductor chip according to this embodiment of the present invention, such that the operation of the ESD protection unit 310 is interrupted. Therefore, no connection is formed between the input pads 301, 303 and the ground voltage pad 305, and the semiconductor chip normally operates.

Second, when static electricity is generated while no power is being applied to a semiconductor chip, the NMOS transistor 306 and the ESD protection unit 310 in the ESD protection circuit are turned on according to this embodiment of the present invention as shown in FIG. 3.

More specifically, when static electricity is generated with no power being applied to the semiconductor chip, a static electricity voltage is produced between the drain and source terminals of the NMOS transistor 306.

When the static electricity voltage is a negative voltage, the NMOS transistor 306 is turned on in a forward bias state. When the static electricity voltage is a positive voltage, the NMOS transistor 306 is turned on in a reverse bias state.

Therefore, the NMOS transistor 306 is turned on and transmits static electricity to the ESD protection unit 310. Then, as the ESD protection unit 310 receives the static electricity transmitted from the NMOS transistor 306, the ESD protection unit 310 starts to discharge the static electricity to the power source voltage line 302 or the ground voltage line 304.

That is, when the static electricity voltage is a negative voltage, the NMOS transistor 306 is turned on and transmits static electricity to the ESD protection unit 310. Then, the ESD protection unit 310 is turned on and performs an ESD protection function.

As can be readily seen from the above descriptions, in the ESD protection circuit according to this embodiment of the present invention, static electricity is selectively transmitted to the ESD protection unit 310 through the NMOS transistor 306 connected between the input/output pad 301 and the node ‘B’ of the ESD protection unit 310.

Further, the NMOS transistor 306 connected between the input/output pad 301 and the node ‘B’ of the ESD protection unit 310 functions to decrease the junction capacitance of the semiconductor chip.

More specifically, the NMOS transistor 306 is connected in series with the PMOS transistor 311 or the NMOS transistor 312 through the node ‘B’.

Here, the NMOS transistor 306, the PMOS transistor 311, and the NMOS transistor 312 all of which have capacitance components, and the capacitance of the NMOS transistor 306 is connected in series with the capacitances of the PMOS transistor 311 and the NMOS transistor 312 through the node ‘B’.

Hence, due to the presence of the NMOS transistor 306, the ESD protection circuit according to this embodiment of the present invention has a junction capacitance, which is less than the summed capacitance of the PMOS transistor 311 and the NMOS transistor 312.

FIG. 4 is a circuit diagram illustrating an ESD protection circuit in accordance with another embodiment of the present invention.

Referring to FIG. 4, the ESD protection circuit according to this embodiment of the present invention comprises a plurality of input/output pads 401, 402, an ESD protection unit 410, and a plurality of switching elements 403, 404, each of which is respectively connected between one of the plurality of input/output pads 401 and 402 and the ESD protection unit 410.

Since the ESD protection unit 410 and the switching elements 403, 404 are structured in the same manner as the ESD protection unit 310 and the NMOS transistor 306 of FIG. 3, the detailed description relating to 403, 404, 410 will be omitted.

In the ESD protection circuit according to this embodiment of the present invention as shown in FIG. 4, a semiconductor chip can operate normally during a normal operation, since the plurality of switching elements 403, 404 are all turned off and the respective input/output pads 401, 402 are therefore disconnected from each other.

When static electricity is generated while no power is being applied to the semiconductor chip, the ESD protection unit 410 would operate properly as all of the NMOS transistors 403, 404 would turn on and transmit the static electricity to the ESD protection unit 410.

Therefore, in the ESD protection circuit according to this embodiment of the present invention, unlike the conventional ESD protection circuit of FIG. 2, the plurality of NMOS transistors 403, 404 can operate properly or perform an ESD protection operation through one ESD protection unit 410.

In other words, since the ESD protection circuit according to this embodiment of the present invention has (1) a number of the NMOS transistors 403, 404 and (2) the same number of the input/output pads 401, 402 corresponding to the NMOS transistors 403, 404, and (3) one ESD protection unit 410, the area occupied by the ESD protection circuit can be decreased considerably when it is compared to the area occupied by a conventional ESD protection circuit, which requires one ESD protection circuit for each input/output pad in a semiconductor chip.

It is noted that the ESD protection circuit according an embodiment of the present invention can be configured in a manner that one or more of the ESD protection units can be arranged to connect to a plurality of or a certain combinations of the input/output pads when it is called for by the design demands.

More specifically, in the ESD protection circuit according to an embodiment of the present invention, a plurality of input/output pads can be connected to one ESD protection unit, or depending upon a designed situation, a plurality of input/output pads can be divided into groups and one ESD protection unit can be connected to each group.

By connecting a plurality of ESD protection circuits (one of which 410 shown in FIG. 4) to the internal circuits of a semiconductor chip, it is possible to decrease the area occupied by the ESD protection circuit in the semiconductor chip.

As is apparent from the above descriptions, the ESD protection circuit according to the present invention provides advantages in that it is possible to decrease a junction capacitance component through the capacitance of a switching element connected in series with the capacitance of an ESD protection unit.

Also, in the present invention, due to the fact that the connection to an input/output pad is controlled through the switching element connected between the input/output pad and the ESD protection unit, one ESD protection unit can be connected to a plurality of input/output pads to decrease an area occupied by the ESD protection circuit in a semiconductor chip.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. An ESD protection circuit including an input/output pad through which static electricity is capable of being introduced, a power source voltage pad, and a ground voltage pad, comprising:
a first voltage line connected to the power source voltage pad;
a second voltage line connected to the ground voltage pad;
an ESD protection unit connected between the first voltage line and the second voltage line to provide a static electricity discharge path; and
a switch connected between the input/output pad and the ESD protection unit and performing switching operations based on the presence of the static electricity.

2. The ESD protection circuit of claim 1, wherein the switch comprises a diode which is turned on in a forward bias state when the static electricity has a negative voltage and is turned on in a reverse bias state when the static electricity has a positive voltage.

3. The ESD protection circuit of claim 1, wherein the switch comprises an NMOS transistor which has a drain terminal connected to the input/output pad and gate and source terminals commonly connected to the ESD protection unit.

4. The ESD protection circuit of claim 1, wherein the ESD protection unit comprises:
a first diode means connected between the first voltage line and the switch;
a second diode means connected between the switch and the second voltage line; and
clamp means connected between the first voltage line and the second voltage line.

5. The ESD protection circuit of claim 1, wherein the switch is turned on when the static electricity is introduced while no power is being applied to the power source voltage pad.

6. An ESD protection circuit including a plurality of input/output pads through which static electricity is capable of being introduced, a power source voltage pad, and a ground voltage pad, comprising:
a first voltage line connected to the power source voltage pad;
a second voltage line connected to the ground voltage pad;
an ESD protection unit connected between the first voltage line and the second voltage line to provide a static electricity discharge path; and
a plurality of switches, each of which is connected between one of the plurality of input/output pads and the ESD protection unit, and performing switching operations based on the presence of the static electricity.

7. The ESD protection circuit of claim 6, wherein at least one of the switches comprises a diode which is turned on in a forward bias state when the static electricity has a negative voltage and is turned on in a reverse bias state when the static electricity has a positive voltage.

8. The ESD protection circuit of claim 6, wherein at least one of the switches comprises an NMOS transistor which has a drain terminal connected to one of the input/output pads, and wherein gate and source terminals are commonly connected to the ESD protection unit.

9. The ESD protection circuit claim 6, wherein the ESD protection unit comprises:
a first diode means connected to the first voltage line and to a first node of the ESD protection circuit; a second diode means connected to the first diode means through the first node and to the second voltage line, wherein each switch is connected to the first node; and
clamp means connected between the first voltage line and the second voltage line.

10. The ESD protection circuit of claim 6, wherein at least one switch is turned on when the static electricity is introduced when no power is being applied to the power source voltage pad.
